(19) United States
(12) Patent Application Publication
(10) Pub. No.: US 2015/0289436 A1
(43) Pub. Date: Oct. 15, 2015

(54) IMPROVEMENTS IN AND RELATING TO LOAD TRANSFER

(71) Applicant: Kalvin Jit SINGH, Hamilton (NZ)

(72) Inventor: Kalvin Jit Singh, Hamilton (NZ)

(21) Appl. No.: 14/438,289

(22) PCT Filed: Nov. 4, 2013
(86) PCT No.: PCT/NZ2013/000195

§ 371 Date: Apr. 24, 2015

(30) Foreign Application Priority Data
Nov. 6, 2012 (NZ) 603439

(51) Int. Cl. A01B 63/112

(52) U.S. Cl. CPC A01B 63/112

(57) ABSTRACT

A load sensing and lift cylinder adjusting system for a three-point linkage arrangement on a tractor, which includes; a control system and load setting system; a load sensing system in the form of a load sensing proportional valve in fluid connection with the lift cylinder; a load adjusting system which includes a load sense pump connected to the load sensing proportional valve and the tractor's hydraulic oil supply; the load sensing system monitors load on the lift cylinder via oil pressure from within the lift cylinder and if the load drops from the pre-set load this sends a signal to the load adjusting system which diverts oil from a hydraulic oil supply to the lift cylinder to maintain the pre-set load; if the pre-set load is exceeded a signal is sent to the load adjusting system which diverts oil from the lift cylinder back to the tractor's hydraulic oil supply.

### TECHNICAL FIELD

The present invention relates to improvements in and relating to load transfer.

### BACKGROUND ART

The present invention has particular application to both tractors which tow implements via means of 3 point linkage (hitch) or simply via a tow bar.

A major problem faced by tractors when towing (pulling) a heavy load, is that the effective load being towed by the tractor, can vary considerably when traversing variable ground conditions, and traction can suffer as a result. Some non-limiting examples of such varying ground conditions can include:

Soil and rocky or stony ground;

Dry and muddy and/or wet ground;

Flat and undulating ground; or

Hills and flat ground.

Typically, difficulties are encountered at the interfaces between the different ground conditions.

The above discussed loss of traction experienced by a tractor towing an implement, has over the years, been sought to be addressed in a number of different ways, including: the addition of ballast to the tractor; draft control systems; and automatic performance management systems. However, these systems still all have their drawbacks as detailed below.

### Ballast

All conventional tractors available on the market today all still require the addition ballast which is “dead” weight (in the order of several tons or more depending on the size of the tractor and load to be towed) that is added to the tractor to increase traction. The requirement for ballast to be added to tractors remains despite tractors being fitted with draft control and automatic management systems to combat loss of traction. As will be understood the addition of dead weight to be moved by a tractor in addition to the load to be towed significantly reduces fuel economy.

### Draft Control

The majority of new tractors today are fitted with a draft control system which utilises a sensor which senses increased draft forces arising from the towed implement pulling back on the hitch arms of a three point hitch, in situations of increased drag and indicating the potential for a loss in traction. When increased draft forces are encountered, the draft control system responds by lifting the hitch arms, in an attempt to reduce the drag, by lifting the implement a little further out of the ground. However, this response by the draft control system can eventually become a problem, when the draft control automatically engages several times, during a towing operation, as the repeated lifting response causes the implement to be totally lifted out of the ground—which is of course undesirable. A problem with the draft control system is that it cannot operate in reverse and lower the arms once reduced drag is encountered. It is a one way system.

### Automatic Management Systems

Automatic management systems sense wheel slippage by monitoring wheel speed and true ground speed. When there is a difference of 10-15% between the wheel speed and true ground speed, the system recognises this as a wheel slippage event, and operates the lifting arms to lift the implement out of the ground a fraction to reduce drag. However, these systems are notoriously unreliable in practice as:
by the time wheel slippage is detected (i.e. when there is a 10-15% speed differential) it is often too late as the drag forces being experienced are significant;
the system typically overcompensates due to the significant drag forces and ends up lifting the implement totally out of the ground;
the system is not geared to lower the implement after a wheel slippage event has occurred.

It is an object of the present invention to address the foregoing problems or at least to provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### DEFINITIONS

The term ‘drawbar’ as used herein refers to a beam on the front of a towed implement used for attaching to a tow bar on a tractor to enable towing.

The term ‘low bar’ as used herein refers to a bar on the back of a tractor used for towing.

The term three-point linkage arrangement as used herein refers to:
a conventional three point linkage on the rear of a tractor as is well known in the art;
a tow bar only tractor which has been modified to also pull from the front of the tractor as disclosed in FIG. 3 of this specification and as also detailed in WO 2011/025392.

### DISCLOSURE OF THE INVENTION

According to one aspect of the present invention there is provided a load sensing and lift cylinder adjusting system for a three-point linkage arrangement on a tractor, which includes:
a hydraulic oil supply;
a control system and load setting system;
a load sensing system in the form of a load sensing proportional valve in fluid connection with the lift cylinder;
a load adjusting system which includes a load sense pump connected to the load sensing proportional valve and the tractor's hydraulic oil supply;
   wherein the load setting system is configured to allow a desired load to be pre-set for lift cylinder(s) of the three point linkage, when first connected to a towed implement, prior to commencing a work operation with said implement, and once the load setting system has pre-set the load, the load sensing system is informed of a pre-set load being selected and then monitors the load on the lift cylinder via the oil pressure from within the lift cylinder and:
if the load drops from the pre-set load this sends a signal to the load adjusting system which diverts oil from a hydraulic oil supply to the lift cylinder to maintain the pre-set load;
if the pre-set load is exceeded a signal is sent to the load adjusting system which diverts oil from the lift cylinder back to the tractor's hydraulic oil supply.

According to another aspect of the present invention there is provided a load sensing and lift cylinder adjusting system for a three-point linkage arrangement on a tractor, substantially as described above, wherein the system includes at least one shock absorbing device capable of absorbing a hydraulic shock wave.

According to another aspect of the present invention there is provided a load sensing and lift cylinder adjusting system for a three-point linkage arrangement, substantially as described above, wherein the control system is in the form of PLC and load setting system, which utilises a user interface located in the cab of the tractor, to allow for input of desired load transfer information into the control system.

According to another aspect of the present invention there is provided a load sensing and lift cylinder adjusting system for a three-point linkage arrangement, substantially as described above, wherein it is the load adjusting system which has a directional valve, cooperating with a load sensing proportional valve and load sense pump.

According to another aspect of the present invention there is provided a load sensing and lift cylinder adjusting system for a three-point linkage arrangement, substantially as described above, wherein it is a load sensing proportional valve which detects changes in load and the magnitude of the change in the load.

According to a further aspect of the present invention there is provided a tractor which includes a load sensing and lift cylinder adjusting system for a three-point linkage arrangement substantially as described above.

According to another aspect of the present invention there is provided a method of controlling the lift cylinder(s) used on a three-point linkage arrangement on a tractor comprising the steps of:
setting a desired load on the lift cylinder(s) once an implement has been connected to the three-point linkage arrangement;
monitoring the load on the lift cylinder(s) whilst towing the implement via a load sensing proportional valve;
continually adjusting the lift cylinder(s) to maintain the pre-set load as is required.

### BRIEF DESCRIPTION OF THE DRAWINGS

Further aspects of the present invention will become apparent from the ensuing description which is given by way of example only and with reference to the accompanying drawings in which:

FIG. 1 shows a schematic view of a load sensing and lift cylinder adjusting system for a three point linkage on a tractor in accordance with one preferred embodiment of the present invention;

FIG. 2A shows a schematic view of a tractor towing a towed implement and going over a rise in the ground to illustrate operation of the system shown in FIG. 1;

FIG. 2B shows a schematic view of a tractor towing a towed implement and going over a depression on the ground to illustrate operation of the system shown in FIG. 1;

FIG. 3 shows a schematic view of a tractor sold with a tow bar only which has been modified to include a rear lift cylinder and to also pull from the front of the tractor which can utilise the present invention.

### BEST MODES FOR CARRYING OUT THE INVENTION

The load sensing and lifting cylinder adjusting system of the present invention is made up of the following systems:

First, a control system which is in the form of a PLC and load setting system, which utilises a user interface (control panel) normally located in the cab of the tractor, to allow for input of desired load transfer information into the control system.

Secondly, a load adjusting system which has a directional valve, cooperating with a load sensing proportional valve and load sense pump.

Thirdly, a load sensing system in the form of a load sensing proportional valve which detects changes in load and the magnitude of the change in the load.

These three systems are now discussed in more detail in relation to the drawings.

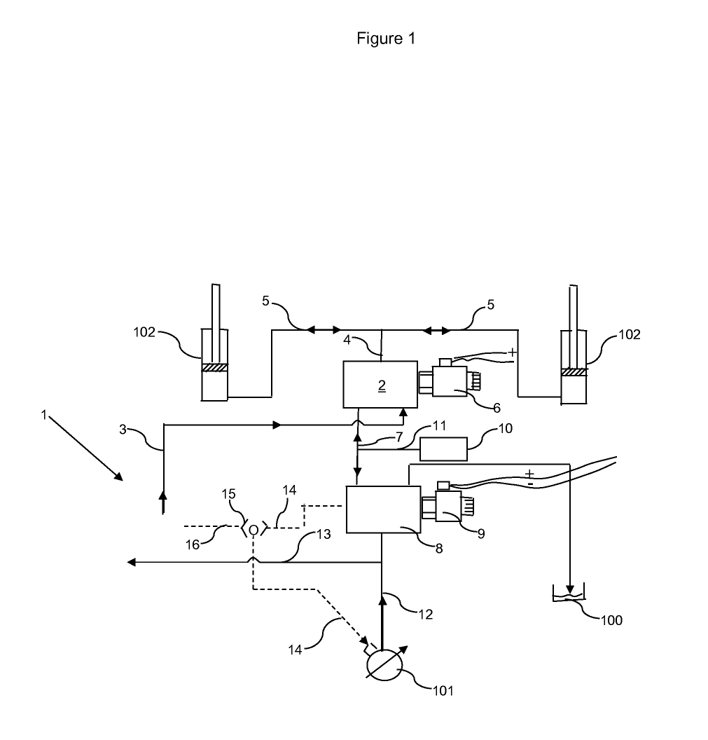

With respect to FIG. 1 there is provided a load sensing and lifting cylinder adjusting system (LAS) for a three-point linkage on a tractor generally indicated by arrow 1.

The LAS 1 integrates into the hydraulic system of a tractor's three point linkage, via a spool type directional valve 2. The directional valve 2 which is connected to the hydraulic supply line (hose) 3 at an inlet port (not shown), which supplies hydraulic fluid from the tractor's hydraulic fluid supply 100, via a load sense pump 101 to hydraulic lift arms (hydraulic rams or cylinders) 102 (of the three point linkage (not shown), at the rear of a tractor (not shown)). The directional valve 2 also has a first inlet/exit port (not shown) connected to a lift arm supply line 4, which in turn is effectively connected to the lift arms 102 via inlet/output line 5.

The directional valve 2 is operated by an associated solenoid 6. The solenoid 6 is connected to a control system PLC and user interface (not shown), in the tractor cab (not shown). The user interface enables a driver (not shown) to activate the LAS 1, and set the desired weight to be transferred from the towed implement (not shown) to the tractor, at which point the control system PLC governs overall operation of the LAS 1.

The solenoid 6 operates the directional valve 5 to direct fluid either:
to the lift arm via an inlet/outlet port (not shown) and lift supply line 4, or
to a load sensing proportional (LSP) valve 8 via second inlet/output port (not shown), and a second inlet/output line 7, which is connected to a load sensing proportional (LSP) valve 8.

The LSP valve 8 is also operated by an associated solenoid 9 which is again connected to and actuated by the control system (not shown). A shock absorber in the form of a nitrogen accumulator 10 is connected to the hydraulic line 7 by way of a hydraulic side branch line 11. The nitrogen accumulator 10 enables the LAS 1 to absorb any shocks experienced in the hydraulic fluid, due to rapid changes in the towed load.

The LSP valve 8 has a first inlet/outlet port (not shown) which connects the LSP valve to the directional valve as aforementioned via line 7. In addition the LSP valve 8 has an inlet line 12, which supplies hydraulic fluid to the LSP valve 8 from the load sense pump 101. Line 12 also has a branch line 13 coming off, which supplies high pressure hydraulic fluid to the tractor system via the load sense pump 101, when the LSP valve 8 shuts off inlet line 12. In addition, the LSP valve 8 also has an outlet port (not shown) and associated line 17, which can redirect hydraulic fluid received from the directional valve 2, in an over pressure situation in the lift cylinders 102, to the tractor's hydraulic fluid supply 100.

The load sense pump 101 also has an additional supply port (not shown) which conventionally can be used for providing hydraulic fluid to towed implements, which have hydraulic equipment thereon. In the present invention, a load sense supply line 14 is connected to the additional supply port on pump 101, and this is connected to the LSP valve 8 via a priority valve in the form of a ball valve 15. The ball valve 15 has a port (not shown) which is connected to a tractor supply line 16. The ball valve 15 senses when the tractors essential services, such as brakes or steering, require pressurised hydraulic fluid, it diverts hydraulic fluid to line 16 in such situations, as a matter of priority. Providing, that fluid to line 16 takes precedence over supplying pressurised hydraulic fluid to the LAS 1, until such time as hydraulic fluid is no longer required by essential services.

In practice, diversion of hydraulic fluid to essential services does not affect operation of the LAS 1, as the need for oil by essential services typically is only required for around 1-3 seconds, at maximum, in most normal situations. It being understood, if essential services require additional pressurised hydraulic fluid for a longer time period, then the tractor is in a serious situation—where the normal towing operation is most likely a low priority.

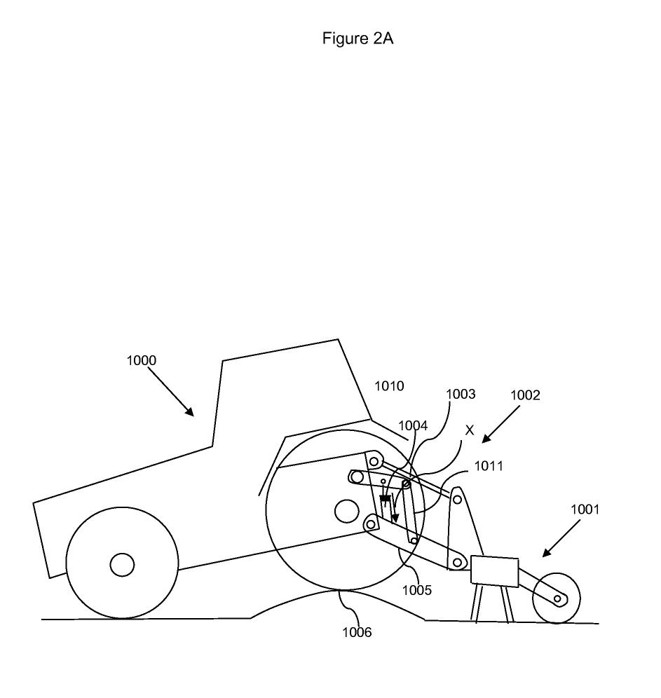

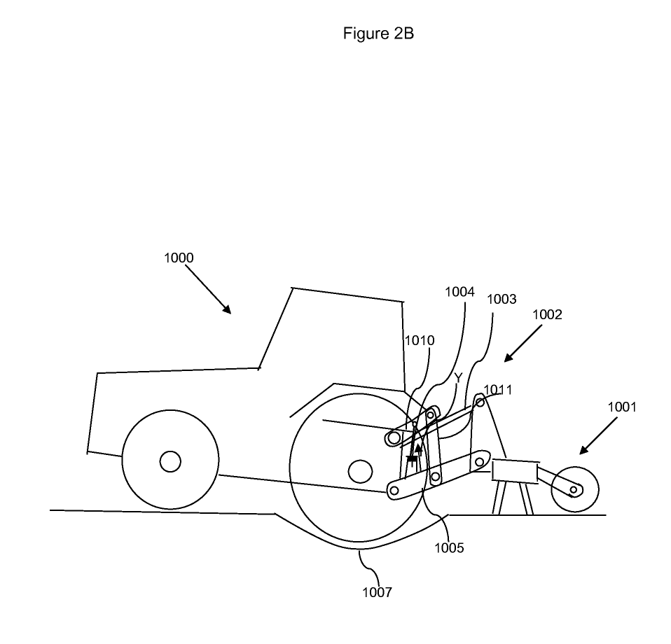

The following description details how the LAS of FIG. 1 operates, in practice, in each of the two scenarios depicted in FIGS. 2A and 2B.

In FIGS. 2A and 2B there is provided a tractor 1000 which is towing a ground working implement 1001 via the three point linkage 1002. The three point linkage has an upper hitch arm 1003 which is connected to the towed implement 1001. A pair of hydraulic lift cylinders 1004 (of which only one is visible) are fixedly mounted to the rear of the tractor 1000 at their base. Each cylinder 1004 has the distal end of their piston rod pivotally connected to a lift arm 1010, which is pivotally connected to a lift rod 1011, to effectively connect the lift cylinders 1004 to the lower hitch arms 1005 as is known in the art.

When the tractor goes over a rise 1006, the lift cylinders 1004 experience a downward force X, this increases the pressure of the hydraulic fluid within the lift cylinders 1004. As the pressure in the cylinder 1004 now exceeds the pre-set load transfer pressure—that the user initially selected after attaching the implement to the tractor—this is sensed by the LSP valve 8. The control system (not shown) upon receiving this information from the LSP, operates the solenoids 6, 9 on the directional and LSP valves 2, 8 respectively, so as to direct hydraulic fluid from the cylinder back to the hydraulic fluid supply of the tractor 100 via line 17. To thereby reduce the pressure in the lift cylinders 1004 until it reaches the pre-set cylinder pressure.

When the tractor goes into a dip 1007 in the ground the lift cylinder 1004 experiences an upward force Y which decreases the pressure of the hydraulic fluid within the lift cylinders 1004. As the pressure in the cylinders 1004 is now below the pre-set load transfer pressure—that the user initially selected after attaching the implement to the tractor—this is sensed by the LSP valve 8. The control system (not shown) upon receiving this information from the LSP valve 8 operates the solenoids 6, 9 on the directional and LSP valves 2, 8 to enable the load sense pump 101 to pump pressurised hydraulic fluid from the tractor's hydraulic fluid supply to the lift cylinders 1004. This occurs until the pressure in the lift cylinders 1004 reaches the pre-set cylinder pressure—as detected by the LSP valve 8.

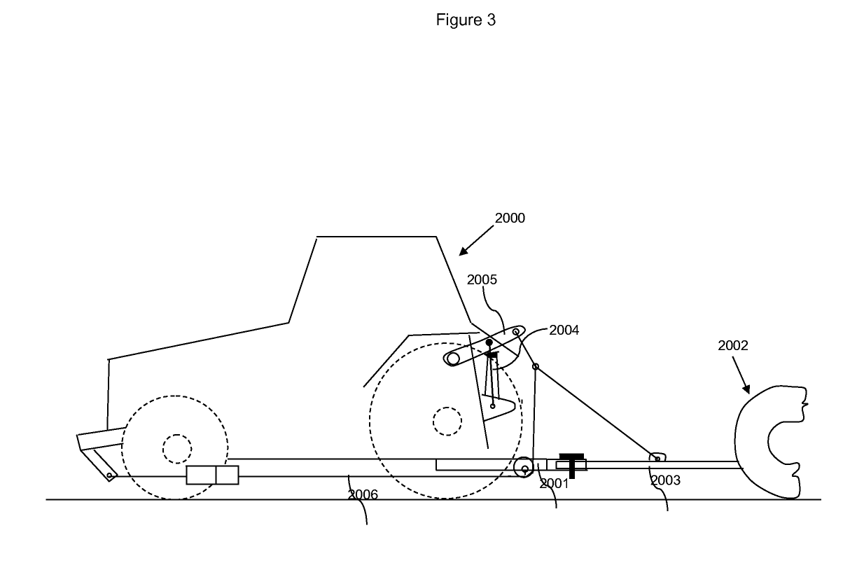

In FIG. 3 there is shown a tractor 2000 which does not have a three point linkage but instead utilises only a tow bar 2001 to pull an agricultural implement 2002, via the implement's drawbar 2003. This tractor has been modified to include a lift cylinder 2004 which is mounted at the base thereof to the rear of the tractor 2000. The tractor 2000 has also been modified to include a lift arm 2005 which is pivotally attached to the rear of the tractor 2002 and to which the piston rod of the cylinder 2004 is pivotally connected. This tractor 2000 has also been modified to:
include the LAS 1 of FIG. 1 (not shown); and
include the load transfer mechanism of the applicant's earlier patent application WO 2011/25392 which has a chain 2006 transferring load from the towed implement to the front of the tractor 2000.

### EXAMPLE 1

In this example a user has hitched a plough to the three point hitch of a tractor. Once the implement is attached to the three point hitch the user can switch on the LAS 1 of FIG. 1.

This energises the solenoids of the directional valve and LSP valve. Prior to the LAS being activated by the user, the directional valve acts a simple one way valve, and only allows hydraulic fluid to be supplied to the lift cylinders, via the tractor's normal draft control system.

However, once the LAS is activated the control system takes over control of the directional valve, and the one way valve is deactivated. The solenoid then actuates the valve in accordance with instructions received from the control system.

Initially, the LAS instructs the directional valve and LSP valve to direct fluid to the lift cylinders, via the load sense pump, until the pressure selected by the user is reached. At this point the LSP valve shuts off the supply line from the load sense pump. As the directional valve and LSP valve are still in fluid communication, via line the LSP can monitor the lift cylinder pressure.

For example, if the user selects a pressure of 800 psi for the lift cylinder, then the control system operated the solenoid on the LSP valve, so that the load sense pump, will pump hydraulic fluid to the lift cylinders, until this pressure is reached as aforementioned.

Then during the towing operation, if the LSP valve senses that the 800 psi pressure is exceeded in the lift cylinders, the control system operates the solenoid associated with the LSP valve to direct fluid back to the tractor's hydraulic fluid supply, until the target 800 psi pressure within the cylinders is reached.

If however, during in a towing operation the LSP senses a decrease in the 800 psi pressure, the control system operates the solenoid associated with the LSP valve, to allow the load sense pump to pump fluid to the cylinders until 800 psi pressure within the cylinders, is once again attained.

### DETAILED DISCUSSION OF ALTERNATE WAYS TO IMPLEMENT THE INVENTION

The control system may be any suitable PLC and the load setting system may be any suitable user interface effectively connected to the PLC to allow a user to select load transfer settings.

The control system and load setting system may include a screen or other visual indicator device, for displaying the load to be transferred to the tractor from the towed implement and/or the pressure at which the lift cylinder, is to be maintained during the towing of the implement.

The load sensing system may include a load sensing proportional valve which is coupled to the lift cylinder of the three point linkage.

The load sensing proportional valve may come in a variety of different forms without departing from the scope of the present invention.

In one embodiment the load sensing proportional valve may include a solenoid which is controlled by the control system and used to operate the load sensing proportional valve.

The load adjusting system may include a directional valve coupled to (i.e. in fluid communication with) a load sensing proportional valve which is in turn coupled to a load sense pump.

The directional valve may have a variety of different configurations for controlling the flow of hydraulic fluid, without departing from the scope of the present invention. For example the directional valve may be selected from:
Spool type directional valves;
Poppet type directional valves;
Rotary type directional valves.
   However this list should not be seen as limiting.

In one embodiment the directional valve may include a solenoid which is controlled by the control system and used to operate the directional valve.

The load sense pump may be the load sense pump which is present in the existing hydraulic system of a tractor.

The load sense pump may be connected to the load sense proportional valve so as to create a stand by pressurised oil circuit, which maintains hydraulic fluid flowing around the circuit at a constant pressure of 300 psi. The load sense pump may be configured so that this pressurised fluid circuit is the default configuration of the valve. The pressurised fluid circuit is always operating unless either: a pressure drop in the lift cylinder is detected, or a ball priority valve which is included in the pressurised fluid circuit, detects that fluid needs to be redirected to the tractor's brakes, or steering, or other essential hydraulic service, as an overriding priority.

Preferred embodiments, of the present invention may have a number of advantages over the prior art which can include, but should not be limited to:
The ability to sense within a fraction of a second any change in lift cylinder pressure from a pre-set pressure;
The ability to react to any change in lift cylinder pressure within a fraction of a second;
The ability to effectively lift or lower the lift cylinders to maintain a constant towed load.

Aspects of the present invention have been described by way of example only and it should be appreciated that modifications and additions may be made thereto without departing from the scope thereof as defined in the appended claims.

1. A load sensing and lift cylinder adjusting system for a three-point linkage arrangement on a tractor, comprising:
a hydraulic oil supply;
a control system in the form of a PLC enables load setting;
a load sensing system in the form of a load sensing proportional valve in fluid connection with the lift cylinder via a directional valve;
a load adjusting system which includes a load sense pump connected to the load sensing proportional valve and the tractor's hydraulic oil supply;
wherein the load setting system is configured to allow a desired load to be pre-set for lift cylinder(s) of the three point linkage, when first connected to a towed implement, prior to commencing a work operation with said implement, and once the load setting system has pre-set the load, the load sensing system is informed of a pre-set load being selected and then monitors the load on the lift cylinder via the oil pressure from within the lift cylinder and:
if the load drops from the pre-set load this sends a signal to the load adjusting system which diverts oil from a hydraulic oil supply to the lift cylinder to maintain the pre-set load; and
if the pre-set load is exceeded a signal is sent to the load adjusting system which diverts oil from the lift cylinder back to the tractor's hydraulic oil supply.

2. The load sensing and lift cylinder adjusting system for a three-point linkage arrangement on a tractor as claimed in claim 1 wherein the system includes at least one shock absorbing device capable of absorbing a hydraulic shock wave.

3. The load sensing and lift cylinder adjusting system for a three-point linkage arrangement as claimed in claim 1 wherein the control system is in the form of PLC and load setting system, which utilises a user interface located in the cab of the tractor, to allow for input of desired load transfer information into the control system.

4. The load sensing and lift cylinder adjusting system for a three-point linkage arrangement as claimed in claim 3 wherein it is the load adjusting system which has a directional valve, cooperating with a load sensing proportional valve and load sense pump.

5. The load sensing and lift cylinder adjusting system for a three-point linkage arrangement as claimed in claim 1 wherein said load sensing proportional valve detects changes in load and the magnitude of the change in the load.

6. A tractor which includes a load sensing and lift cylinder adjustment system for a three-point linkage arrangement as claimed in claim 1.

7. A method of controlling the lift cylinder(s) used on a three-point linkage arrangement on a tractor comprising the steps of:
setting a desired load on the lift cylinder(s) once an implement has been connected to the three-point linkage arrangement;
monitoring the load on the lift cylinder(s) whilst towing the implement via a load sensing proportional valve; and
continually adjusting the lift cylinder(s) to maintain the pre-set load as is required.
